(19) United States
(12) Patent Application Publication
(10) Pub. No.: US 2013/0081653 A1
(43) Pub. Date: Apr. 4, 2013

(54) System and method for tube cleaning

(71) Applicants: Theodosios Kountotsis, Melville, NY (US); Agjah Libohova, E. Setauket, NY (US)

(72) Inventors: Theodosios Kountotsis, Melville, NY (US); Agjah Libohova, E. Setauket, NY (US)

(21) Appl. No.: 13/200,877

(22) Filed: Oct. 4, 2011

(51) Int. Cl. B08B 9/04; B08B 7/00

(52) U.S. Cl. 134/8; 15/104.05

(57) ABSTRACT

A tube cleaning device is presented having a brush including a magnetically attracted component incorporated therein and a magnetic base unit positioned about a tube. The magnetic base unit cooperates with the magnetically attracted component of the brush to advance the brush through the tube. The magnetic base unit may include a housing for accommodating either a single magnet or a pair of opposed magnets or any number of magnetic elements. The magnets may be configured to slidably engage a length of an exterior portion of the tube while positioned within a housing of the magnetic base unit.

### BACKGROUND

1. Field of the Related Art

The present disclosure relates to sanitizing equipment, and more particularly, but not exclusively, to a portable tube cleaning device for cleaning tubes/conduits of varying lengths used at least for transferring food and/or liquids.

2. Description of the Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Therefore, unless otherwise indicated herein, what is described in this section is not prior art to the description and claims in this application and is not admitted to be prior art by inclusion in this section.

There are many situations where it is necessary to clean the interior of hoses and/or tubes. Such cleaning chores often present great challenges due to the inaccessibility of the interior spaces of tubes and hoses. These spaces are not only difficult to access but the tubes or hoses may present particular challenges such as recalcitrant debris and/or the delicate nature of the hose or tube. Also, bends or turns in tubes or hoses also make cleaning difficult.

Conventional cleaning devices, such as brushes attached to a wire handle are only as good as the length of the wire they are attached to. Thus, the length of the tube to be cleaned depends on the length of the wire handle that attaches to the brush. In many instances, it is difficult to insert the wire all the way through the tube in order to clean the entire length of the tube. Additionally, it is not easy to store and handle the brush as a portable unit for outdoor activities. Moreover, the wire may become tangled with the brush. Another issue relates to the replacement of the brush when it is worn out. In such instances, the entire brushing mechanism must be replaced.

Therefore, there is a need for a system and method for effectively cleaning tubes that are not easily accessible via conventional brushes.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The present disclosure provides for a tube cleaning device. The tube cleaning device includes a brush including a magnetically attracted component incorporated therein and a magnetic base unit positioned about a tube. The magnetic base unit cooperates with the magnetically attracted component of the brush to advance the brush through the tube.

In one exemplary embodiment, the magnetic base unit includes a single magnet. The single magnet may circumferentially surround at least one section of the tube. Alternatively, the single magnet may releasably attach to the tube across a length of the tube. Additionally, the single magnet may slidably engage the tube throughout a length of the tube.

In another exemplary embodiment, the magnetic base unit includes a pair of opposed magnets. The pair of opposed magnets are incorporated within a housing configured to slidably engage a length of the tube.

In yet another exemplary embodiment, the housing incorporating the pair of opposed magnets is configured to be adjusted based on a diameter of the tube.

In yet another exemplary embodiment, the brush includes a brush head including a plurality of bristles and a brush handle, at least a portion of the brush head incorporating the magnetically attracted component therein.

Additionally, a plurality of magnetic base units may be positioned across a length of the tube.

The present disclosure also provides a method of cleaning a tube. The method includes the steps of providing a brush including a magnetically attracted component incorporated therein; positioning a magnetic base unit about the tube; and advancing the brush through the tube when the magnetic base unit cooperates with the magnetically attracted component of the brush.

The present disclosure also provides for a conduit cleaner. The conduit cleaner includes a magnetically attracted element embedded within a brush mechanism and a magnetic element creating a magnetic field about at least one segment of a conduit. When the magnetic element approaches the magnetically attracted element, the magnetic element propels the brush mechanism through the conduit.

In one exemplary embodiment, the magnetic element is a single magnet that is configured to slidably engage a length of the conduit. In another exemplary embodiment, the magnetic element is a pair of opposed magnets arranged to be disposed within a housing that is configured to slidably engage a length of the conduit.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

Various embodiments of the present disclosure will be described herein below with reference to the figures wherein:

FIG. 1 is a perspective view of a tube cleaning device, in accordance with the present disclosure;

FIG. 2A is a partial cut-away view of the tube cleaning device of FIG. 1, where one magnet and a brush are illustrated, in accordance with the present disclosure;

FIG. 2B is a further partial cut-away view of the tube cleaning device of FIG. 1, where two magnets and the brush are illustrated, in accordance with the present disclosure;

FIG. 3 is a bottom view of the tube cleaning device, illustrating the two magnets, in accordance with the present disclosure;

FIG. 4 is a perspective view of a tube cleaning device, where a housing incorporating the two magnets is adjustable based on the diameter of the tube, in accordance with another embodiment of the present disclosure;

FIG. 5A is a perspective view of a brush utilized with the tube cleaning assembly of FIGS. 1-4, in accordance with the present disclosure;

FIG. 5B is a cross-sectional view of the brush of FIG. 5A, where an interior portion of the brush includes a magnetically attracted component, in accordance with the present disclosure;

FIG. 6A is a perspective view of a tube cleaning device, where a single magnet circumferentially surrounds the tube, and slidably engages the tube across its length, in accordance with the present disclosure;

FIG. 6B is a perspective view of a tube cleaning device, where a single cut-away magnet attaches to the tube, in accordance with the present disclosure; and

FIG. 7 is a perspective view of a plurality of tube cleaning devices of FIG. 1 cooperating with a lengthy tube to aid in the advancement of the brush therethrough, in accordance with the present disclosure.

The figures depict preferred embodiments of the present disclosure for purposes of illustration only. One skilled in the art will readily recognize from the following discussion that alternative embodiments of the structures and methods illustrated herein may be employed without departing from the principles of the present disclosure described herein.

### DETAILED DESCRIPTION

The present disclosure pertains to tools and methods useful for easily and efficiently cleaning the interior of tubing/tubes and hoses. Advantageously, the bristles or other cleaning surface of the cleaning brush head are sufficiently rigid to facilitate removal of particulate matter and other debris impacted upon the inner surface of the tube or hose. The tube cleaning devices described herein may be used to clean, sterilize, disinfect, purify, unpollute, uncontaminate unwanted substances from tubes and/or hoses to create at least hygienic, anti-bacterial, germ-free, and sanitary regions within the tubes and/or hoses.

The tool or apparatus or device or system of the present disclosure may be inserted into an open end of the tube or hose (as defined hereinbelow). The interior surface of the tube or hose may then be brushed free of any particulate matter by simple manipulation of the cleaning device. The cleaning device (e.g., a brush including a magnetically attracted element) is advanced or propelled or guided through the tube or hose via a magnetic element positioned about the tube or hose. When the cleaning is completed, the cleaning tool of the present disclosure may be easily cleaned if necessary and stored in a convenient location. Additionally, in accordance with the present disclosure, the brush including the magnetically attracted element may clean a tube or hose of any length, regardless of the length of the brush.

It is an object of the present disclosure to provide a system and method where the brush is separate and distinct from an actuating unit for actuating the brush, which overcomes the shortcomings presented in the background section in a practical and efficient manner. The actuating unit may be a magnetic base device that cooperates or interacts with a metal core incorporated within the brush. The actuating unit may be isolated from the brush mechanism or brush head. Stated otherwise, the actuating unit may be a separate and distinct element or component with respect to the brush mechanisms or brush heads. In other words, the detached actuating unit may actuate movement of a brush mechanism or brush head when the actuating unit approaches or is in the vicinity of or contacts a tube configured to receive the brush mechanisms or brush heads. The actuating unit interacts with the brush in a non-attachable manner. The actuating unit enables or activates movement of the brush in a contact-less manner. The actuating unit is configured, in certain embodiments, to slidably engage the exterior surface of the tube or hose. However, it is contemplated that the actuating unit merely travels within a close proximity along the length of the tube in a parallel manner (along a longitudinal axis of the tube or hose).

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is intended to cover all modifications, equivalents, and alternatives falling within the spirit and scope of the present disclosure as defined by the claims. Like numbers refer to like elements throughout the description of the figures.

Unless otherwise indicated, all numbers expressing quantities and conditions, and so forth used in the specification and claims are to be understood as being modified in all instances by the term “about.” The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof. The term “comprise,” “comprises,” “comprised,” or “comprising,” if and when used in this document, should be interpreted non-exclusively, i.e., should be interpreted to mean “consisting of or including.”

Prior to describing the present disclosure in further detail, it will first be helpful to define various terms that will be used throughout the following discussion. For example:

The term “connect” or “connecting” may refer at least to adhere, affix, anchor, attach, band, bind, bolt, bond, brace, button, cohere, fasten, couple, embed, establish, fix, grip, hold, hook, implant, link, lock, lodge, screw, seal, rivet, tack on, tighten, or unite. The term “connect” or “connecting” may at least refer to linking/fastening/attaching/locking any type of materials or units or components or elements in a removable or detachable or interchangeable manner. The term “connect” or “connecting” may also refer to at least materials or units or components or elements associated with each other or in operable communication with each other or cooperating with each other or in operative communication with each other. The term “connect” may be used interchangeably with the terms “cooperate” and/or “attach.”

The term “tube” is used herein to refer to at least a passage, a pathway, a conduit, a duct, a pipe, a pipeline, a pipette, a hose, a funnel, a cable, a channel, a cannula, a straw, a tunnel, a drain, a vessel, a vent or any type of open-ended hollow structure. The term “tube” may refer to any portion or segment of a tube of any length, of any size, and of any shape. The term “tube” may be configured to receive any type of liquid or non-liquid substance therethrough.

The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

Reference will now be made in detail to embodiments of the present disclosure. While certain embodiments of the present disclosure will be described, it will be understood that it is not intended to limit the embodiments of the present disclosure to those described embodiments. To the contrary, reference to embodiments of the present disclosure is intended to cover alternatives, modifications, and equivalents as may be included within the spirit and scope of the embodiments of the present disclosure as defined by the appended claims.

Embodiments will be described below while referencing the accompanying figures. The accompanying figures are merely examples and are not intended to limit the scope of the present disclosure.

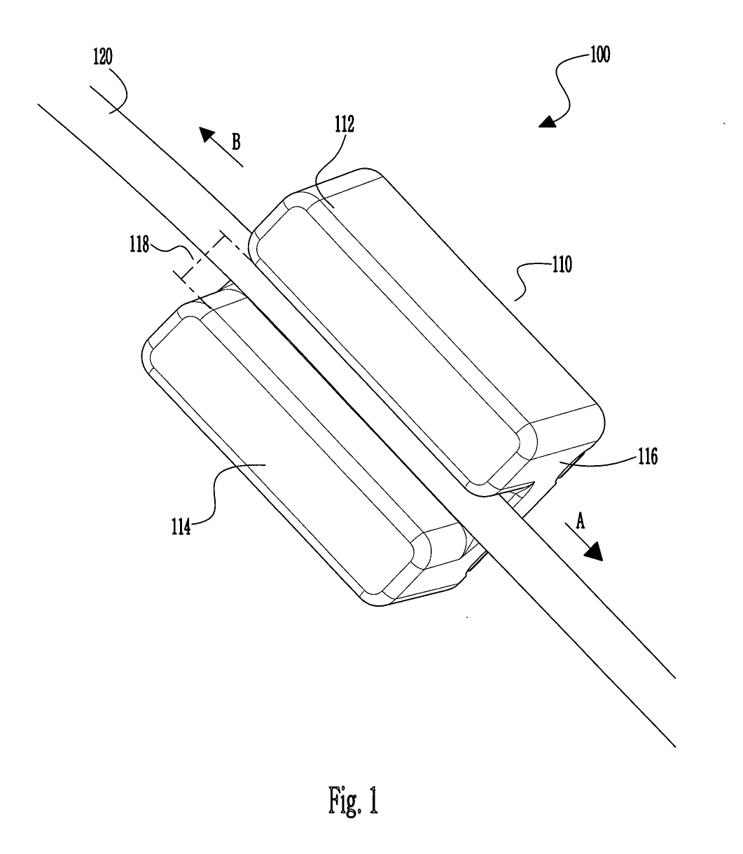

With reference to FIG. 1, there is presented a perspective view of a tube cleaning device, in accordance with the present disclosure.

The tube cleaning device 100 includes a housing 110 configured to cooperate and move along tube 120. The housing 110 may include a first side 112 in parallel to a second side 114. The first and second sides 112, 114 are connected to each other by a third side 116. The housing 110 is shown as a substantially “C-shaped” housing, where an interior portion of the first and second sides 112, 114 envelope or accommodate or wrap around at least a portion of the tube 120. However, one skilled in the art may contemplate any shape or size for the housing 110. The shape of the housing 110, as shown in FIG. 1, creates a gap 118 configured to receive the tube 120. The gap 118 may be considered an opening or cavity or slot or space or recess. Once the housing 110 is connected to the tube 120, the housing 110 is adapted to travel along a length of the tube 120, in a longitudinal direction, as illustrated by arrows “A” and “B.”

The tube 120 may be any type of tubing contemplated by one skilled in the art. Exemplary tubes may include at least Tygon® tubing, polyethylene tubing, polypropylene tubing, polyurethane tubing, Chemflor® tubing, food and beverage tubing, medical grade tubing, fuel and oil tubing, color coded tubing, air and water hose tubing, Bev-A-Line tubing, heat shrinkable tubing, Kynar® tubing, metric tubing, Norprene® tubing, nylon tubing, PVC tubing, silicone tubing, PTFE tubing, Vinyl tubing, flexible tubing, semi-flexible tubing, rigid tubing, braid tubing, LDPE tubing, and HDPE tubing or a combination thereof.

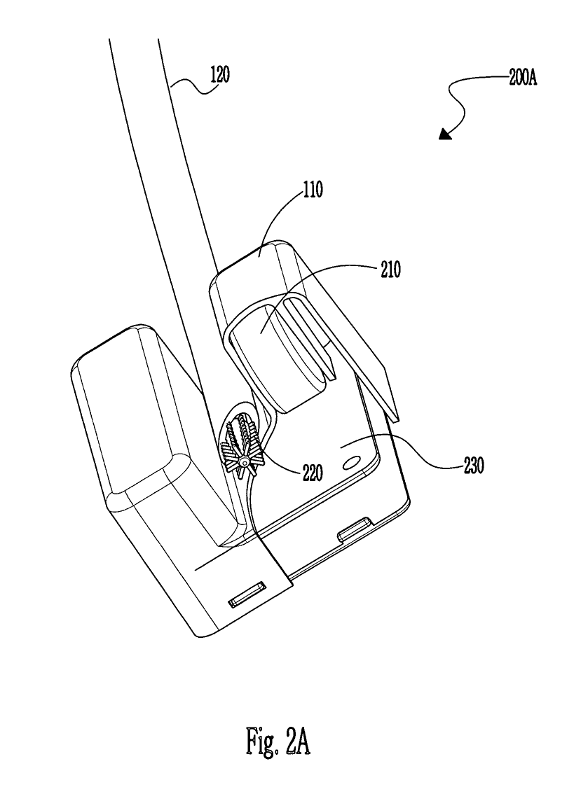

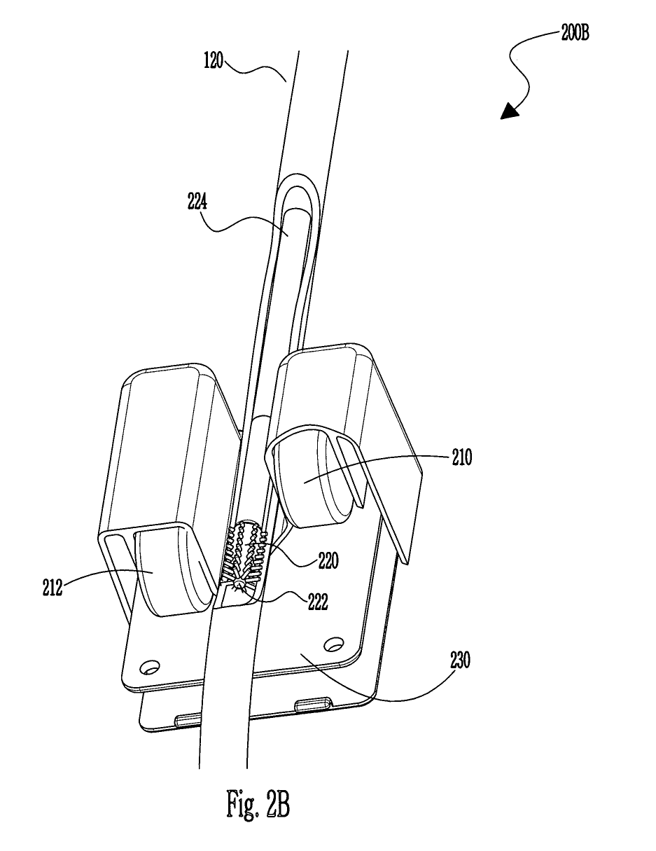

With reference to FIGS. 2A and 2B, there is presented partial cut-away views of the tube cleaning device of FIG. 1, where a magnet (or magnets) and a brush are illustrated, in accordance with the present disclosure.

The cut-away view 200A illustrates components located within the housing 110. For instance, a first magnet 210 is partially shown, as well as a portion of the brush 220. The housing is supported to or mounted on a base 230 to stabilize the first magnet 210 and the tube 120 received in the housing 110.

The cut-away view 200B further illustrates components located within the housing 110. For instance, both first magnet 210 and second magnet 212 are depicted. The first and second magnets 210, 212 are configured to be in opposed relation to each other on opposite ends of the housing 110. The first and second magnets 210, 212 are shown to be circular in shape. However, the first and second magnets 210, 212 may be constructed in any suitable shape and may be constructed to any suitable size.

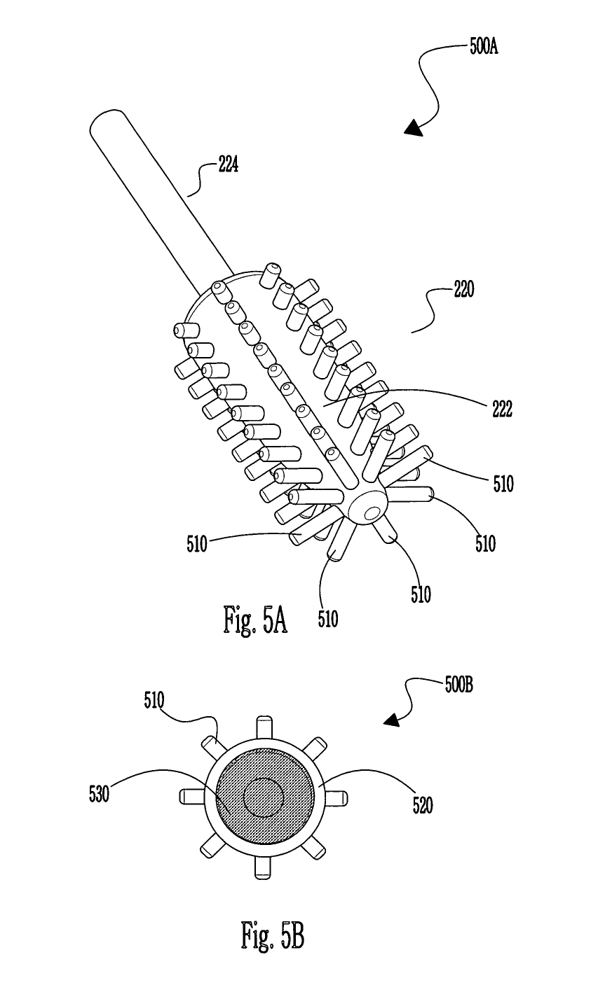

Additionally, the brush 220 is depicted having a brush head 222 and a brush handle 224. Brush handle 224 may be optional. The brush 220 includes a magnetically attracted component or element incorporated therein (see FIG. 5B) or magnet. The housing 110 including the first and second magnets 210, 212 may be referred to as a magnetic base unit. The magnetic base unit may be positioned about the tube 120. The magnetic base unit cooperates with the magnetically attracted component of the brush 220 to advance or propel or guide the brush 220 through the tube 120.

For example, a user (not shown) may wish to clean the interior portion of the tube 120. The user inserts the brush 220 at one end of the tube 120. The user then attaches or slidably engages the magnetic base unit, having the first and second magnets 210, 212 incorporated within the housing 110, along the length of the tube 120. As the user “slides” the magnetic base unit across the length of the tube 120, the magnetically attracted component (see FIG. 5B) of the brush 220 is activated or interacts with or is magnetically actuated by the first and second magnets 210, 212 of the magnetic base unit, so that the brush 220 travels along the interior portion of the tube 120 in accordance with the back and forth movements of the magnetic base unit. The magnetically attracted component need not be a magnet. This movement enabled by magnetism allows for the cleaning of the tube 120.

Both the first magnet 210 and the second magnet 212 may be permanent magnets. A permanent magnet is an object made from a material that is magnetized and creates its own persistent magnetic field. An example includes a refrigerator magnet used to hold notes on a refrigerator door. Materials that may be magnetized, that are usually the ones that are strongly attracted to a magnet, are called ferromagnetic (or ferrimagnetic). It is envisioned that the brush component (see FIG. 5B) may be a ferromagnetic component. Ferromagnetic components may include iron, nickel, cobalt, some alloys of rare earth metals, and some naturally occurring minerals, such as lodestone. Ferromagnetic materials may be divided into magnetically “soft” materials like annealed iron, which may be magnetized but do not tend to stay magnetized, and magnetically “hard” materials, which do. One skilled in the art may contemplate using any types of magnetic materials to create first and second magnets 210, 212, as well as the brush component, described below with reference to FIG. 5B.

However, both first and second magnets 210, 212 may be electromagnets. An electromagnet is made from a coil of wire that acts as a magnet when an electric current passes through it but stops being a magnet when the current stops. Often, the coil is wrapped around a core of ferromagnetic material like steel, which enhances the magnetic field produced by the coil. The overall strength of a magnet is measured by its magnetic moment or, alternatively, the total magnetic flux it produces. The local strength of magnetism in a material is measured by its magnetization. One skilled in the art may envision utilizing any type of magnet of any suitable strength in order to advance or propel or guide, for example, a brush, as described herein, through a tube, as defined herein.

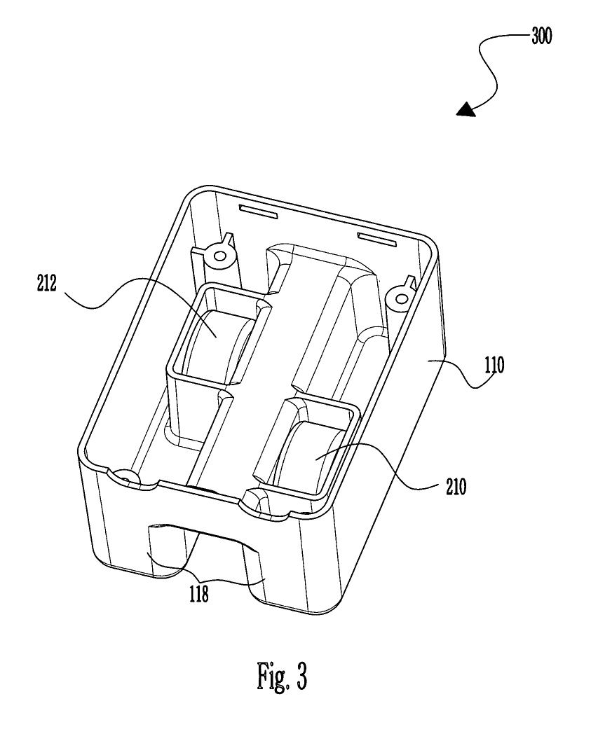

With reference to FIG. 3, there is presented a bottom view of the tube cleaning device, illustrating the two magnets, in accordance with the present disclosure.

The bottom view 300 of the housing 110 depicts a portion of the first and second magnets 210, 212.

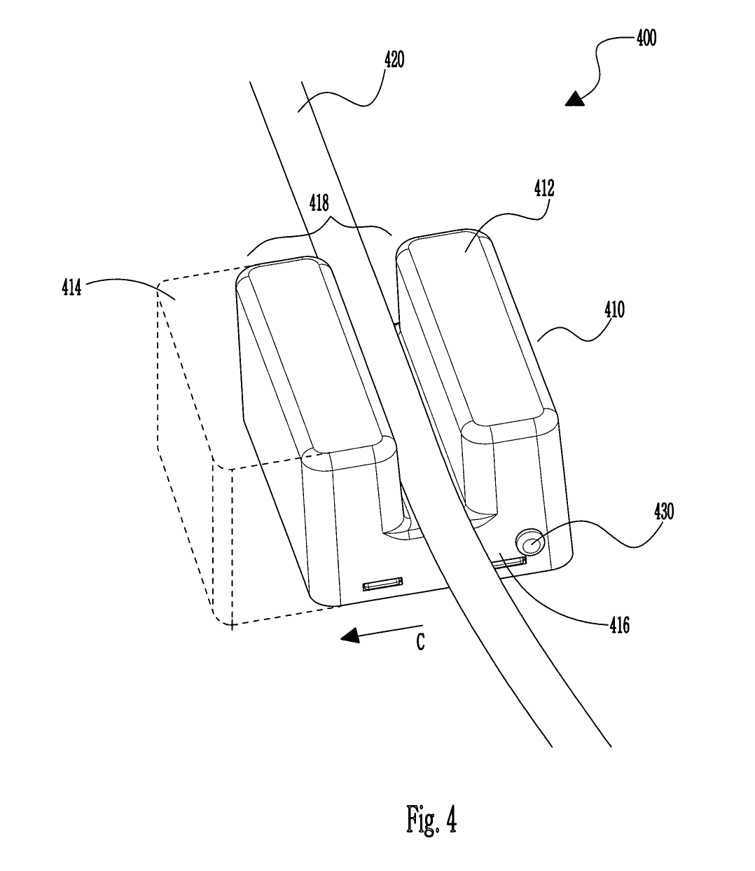

With reference to FIG. 4, there is presented a perspective view of a tube cleaning device, where a housing incorporating the two magnets is adjustable based on the diameter of the tube, in accordance with another embodiment of the present disclosure.

The tube cleaning device 400 includes a housing 410 configured to cooperate and move along tube 420. The housing 410 may include a first side 412 in parallel to a second side 414. The first and second sides 412, 414 are connected to each other by a third side 416. The housing 410 is shown as a substantially “C-shaped” housing, where an interior portion of the first and second sides 412, 414 envelope or accommodate or wrap around at least a portion the tube 420. However, one skilled in the art may contemplate any shape or size for the housing 410. The shape of the housing 410 creates a gap 418 configured to receive the tube 420. The gap 418 may be considered an opening or cavity or slot or space or recess.

As described above with reference to FIG. 1, once the housing 410 is connected to the tube 420, the housing 410 is adapted to travel along a length of the tube 420, in a longitudinal direction, as illustrated by arrows “A” and “B” (see FIG. 1). However, in certain instances, the tube 420 may not be able to conform to the gap 418, due to the diameter of the tube 420. For instance, the diameter of the tube 420 may be too large to be accommodated by the gap 418. As such, an adjustment mechanism 430 may be built into the housing 110 (or the magnetic base unit) so that the housing 410 may be adjusted according to the diameter of the tube 420. Thus, any tube with any diameter may be easily connected between the first side 412 and the second side 414 of the housing 410. The adjustment mechanism 430 may be any type of button mechanism, switch mechanism, actuating mechanism, etc. having a plurality of different levers (not shown) for adjusting the housing the “C” direction. One skilled in the art may contemplate a number of different electro-mechanical mechanisms for adjusting the size of the magnetic base unit based on the diameter of the tube to be received.

With reference to FIG. 5A, there is presented a perspective view of a brush of utilized with the tube cleaning assembly of FIGS. 1-4, in accordance with the present disclosure. With reference to FIG. 5B, there is presented a cross-sectional view of the brush of FIG. 5A, where an interior portion of the brush includes a magnetically attracted component, which does not necessarily have to be a magnet (e.g., could be any type of article, item, object, material, product or element attracted to magnetism).

The perspective view 500A depicts brush 220 having a brush head 222 and a brush handle 224. The brush head 222 may include a plurality of bristles 510. The plurality of bristles 510 may be equally spaced apart from each other. The brush 220 may be configured to snugly fit within a tube in order to clean the tube 120, 420. The cleaning of the tube may include the removal of residue that builds up along the interior surface of the tube 120, 420.

The cross-sectional view 550B depicts the interior portions of the brush head 222. The brush head 222 may include a magnetically attracted component 530 incorporated or embedded therein. The magnetically attracted component 530 may be surrounded by an outer member 520 of the brush head 222. The brush 220, as well as the brush head 222 and the brush handle 224 may be constructed from a plurality of different materials, including, but not limited to plastic, wood, and metal. Once again, the brush handle 224 may be optional.

The brush head 222 of the brush 220 typically includes stiff bristles 510 having sufficient rigidity to remove caked-on dust, dirt, and grime from the interior of a tube or hose. The brush head 222 may have, for example, stiff plastic bristles 510. Other appropriate materials, including, for example, rubber and metal, may be used to construct the brush head 222. The plurality of bristles 510 may come in a variety of lengths and thicknesses, depending on the amount and type of cleaning required. The brush head 222 may be a cylindrical brush, the brush being available in a variety of diameters and lengths matching the various diameters of tubes or hoses to be cleaned. Those skilled in the art, having the benefit of the instant disclosure, will appreciate that the brush 220 may be made a variety of sizes to accommodate uses in different applications.

In one embodiment, the brush head 222 includes stiff bristles 510 having sufficient rigidity to remove caked-on dust, dirt, and grime from the interior of a tube or hose attached to a semi-rigid brush handle 224. The semi-rigid brush handle 224 may come in a variety of lengths and thicknesses, depending on the amount of cleaning required. However, the semi-rigid brush handle 224 is merely optional. The plurality of bristles 510 may be in segmented relation to each other in a variety of different geometric configurations.

Nevertheless, the length of the brush handle 224 is immaterial to the tube cleaning devices described herein. The brush 220 may travel or advance through any length tube or hose regardless of the length of the brush handle 224. The extent of reach of the brush 220 within a tube is not dependent on the length of the brush handle 224. The extent of reach of the brush 220 is based on the interaction or cooperation between the magnetic magnetically attracted component 530 and the first and second magnets 210, 212 positioned within the magnetic base unit. In other words, magnetic properties are used to propel or advance or guide the brush 220 through the tubes or hoses described herein, not the length of the brush handle 224, which is immaterial.

Additionally, the plurality of bristles 510 may be dipped in or coated with a fluid for cleaning the interior portions of tubes and/or hoses. The fluid may generally include, without limitation: any all-purpose cleaner, oil or water based dust inhibitor, anti-static, anti-microbial, antibacterial, sanitizing and de-odorizing agent, dusting agent, glass cleaner, other cleaning agent, wax, polish or shining agent, softening agent, friction-enhancing compound, perfumes, dish cleaner, soap, or other personal care product, etc. Basically, any type of cleaning agent may be used on the bristles 510 of the brush head 222 to clean the interior of the tube 120, 420.

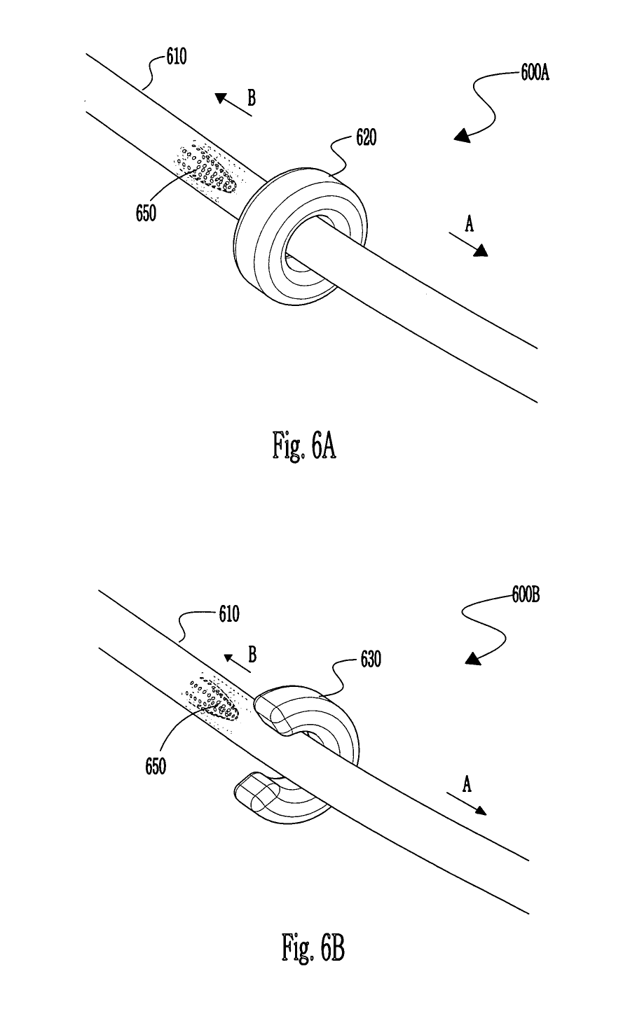

With reference to FIG. 6A, there is presented a perspective view of a tube cleaning device, where a single magnet circumferentially surrounds the tube, and slidably engages the tube across its length, in accordance with the present disclosure.

The tube cleaning device 600A depicts a single magnet 620 circumferentially positioned about a tube 610. A brush mechanism 650 including a magnetically attracted component therein may be used in cooperation with the single magnet 620 in order to advance or propel or guide the brush mechanism 650 through the entire length of the tube 610. The brush mechanism 650 is configured to frictionally engage the interior walls or surface of the tube 610 in order to, for example, remove residue that builds up on the interior sections or segments or portions of the tube 610.

With reference to FIG. 6B, there is presented a perspective view of a tube cleaning device, where a single cut-away magnet attaches to the tube, in accordance with the present disclosure.

The tube cleaning device 600B depicts a single magnet 630 attached to or connected to or snapped onto the tube 610. The brush mechanism 650 including a magnetically attracted component therein may be used in cooperation with the single magnet 630 in order to advance or propel or guide the brush mechanism 650 through the entire length of the tube 610. The brush mechanism 650 is configured to frictionally engage the interior walls of the tube 610 in order to, for example, remove residue that builds up on the interior sections or segments or portions of the tube 610.

The single magnets 620, 630 shown in FIGS. 6A and 6B are shown to be circular or semi-circular (e.g., “C-shaped”). One skilled in the art may contemplate using a plurality of different magnets of different strengths and of different shapes and sizes in order to enable the advancement of one or more brushes through any length tubes or hoses, regardless of the length of the handle portions connected to such tubes or hoses, and regardless of the number of twists and turns and contours created by the tube or hose.

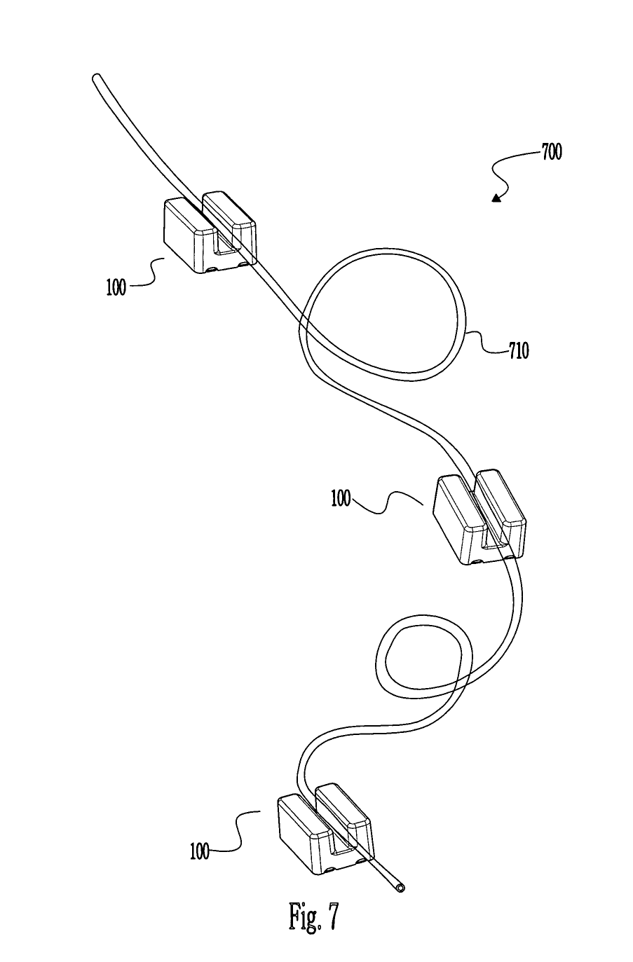

With reference to FIG. 7, there is presented a perspective view of a plurality of tube cleaning devices of FIG. 1 cooperating with a lengthy tube to aid in the advancement of the brush therethrough, in accordance with the present disclosure.

The system 700 merely illustrates that a plurality of tube cleaning devices 100 may be positioned across a length of a tube or hose 710. For example, the tube 710 may be 200 ft long, and thus require the use of, for example, three tube cleaning devices 100, to be used across its length to propel or advance or guide a brush mechanism therethrough to frictionally engage the interior walls or surfaces of the tube 710. Additionally, each tube cleaning device 100 may be manipulated by a different user.

In an alternative embodiment, the magnets within the magnetic base units of the exemplary embodiments of the present disclosure need not actually contact the tubes or hoses. In other words, the magnets within the magnetic base units may merely be brought into proximity or the vicinity of the tube to interact or cooperate or magnetically actuate the magnetically attracted component positioned within the brush.

In another alterative embodiment, the brush head need not include any bristles. The brush head may include, for example, a hook mechanism or a spring mechanism or any other type of stiff member for cleaning the interior portions or segments of tubes or hoses. The brush may be at least one of a twisted brush, a power tube brush, a bottle cleaning brush, a nylon brush, an abrasive nylon brush, a burr brush, a side tuft cleaning brush, a power fitting brush, a condenser tube brush, a laboratory brush, a heavy-duty brush, and a flue brush or a combination thereof. One skilled in the art may contemplate any type of brush with or without bristles for cleaning the interior of a tube, as defined herein.

It will be appreciated that various embodiments of brushes may be employed in a variety of applications and, accordingly, variables including, but not limited to, the geometry defined by the magnetically attracted component, as well as the size, and/or orientation of the magnetically attracted component may be varied either alone or in various combinations as required to suit a particular application and/or to facilitate achievement of one or more desired results. In one example, shorter or longer magnetically attracted component sections may be employed to suit a particular desired application.

The tube cleaning device of the present disclosure may be useful in a number of different applications. Described below, in a non-limiting manner, are exemplary applications.

For example, the tube cleaning devices described herein may be used for garden hoses that may accumulate dirt or any other type of debris.

For example, the tube cleaning devices described herein may be applied to the field of vacuum cleaners. Obviously, the tubes or hoses used for vacuum cleaners accumulate a plethora of debris that is difficult to remove with the use of conventional brushes.

For example, the tube cleaning devices described herein may be applied to hydration systems. One such product may be the CamelBak™ backpacks that are connected to a hydration unit via a tube or hose. The cleaning kits sold separately for such backpacks include convention brushes that are bulky and not easily transportable for outdoor enthusiasts.

For example, the tube cleaning devices described herein may be applied to flexible, semi-rigid, or rigid straws used to sip drinks or transfer any type of liquids or non-liquids. The straws may be at least plastic straws or metal straws.

For example, gas barbecue grills present a particular problem. The gas is conducted from the control valve to the barbecue burner by way of a bent venturi tube. The tube is of small diameter, is bent and has air openings. The air openings allow dirt, bugs, spider webs and cocoons to clog the tube, thereby requiring frequent cleaning. For instance, it's extremely important to clean the venturi tubes of any obstructions such as spider webs, etc. This is most important at the start of the grilling season or any other time the grill has not been used for a while. A small web may block the gas flow and cause poor burner performance or a flash back fire. A venturi brush may be used to clean the venturi tubes. However, the venturi brush suffers from the same disadvantages of conventional brushes. The tube cleaning device of the present disclosure may facilitate such cleaning function in the grilling/barbequing field by not requiring a long brush handle to clean tubes or hoses.

For example, various types of tubular medical devices have been employed in the medical field to perform a broad range of important functions. For example, catheters are commonly employed to carry various bodily fluids, including but not limited to, abscess fluids, urinary fluids, or biliary fluids. Other such medical devices include feeding tubes, used to provide nutrition to a patient, hemodialysis tubes, and venous lines. Many of these medical devices are used in long-term treatments. It is important that the interior passageway in these medical devices remain unobstructed. Obstructed or limited flow may extend the recovery time of a patient, resulting in the potential for further complications or infections. Typically, the life of the medical device is limited by buildup in the interior passageway. As a result, after a certain amount of time, the medical device is removed and discarded and a new device is then inserted. Inserting a new medical device however, often implicates additional risks of inducing infection. In addition, the replacement of the medical device increases the overall cost to the patient.

In view of the foregoing problems and shortcomings, it would be an advancement in the art to provide for a brush that facilitates, among other things, safe and effective in situ cleaning of tubular medical devices such as hemodialysis tubes, catheters, feeding tubes, drainage tubes, venous lines, and the like. The tube cleaning device of the present disclosure may facilitate such function in the medical field. Thus, the exemplary embodiments of the present disclosure provide an improved brush which facilitates, among other things, safe and effective cleaning of passageways defined by various medical devices without necessitating removal of the medical device from the patient or otherwise interrupting fluid communication between the patient and the medical device.

In particular, a tube cleaning mechanism suitable for use in facilitating cleaning of a passageway defined by a medical device may be presented, the tube cleaning mechanism including a brush including a magnetically attracted component incorporated therein and a magnetic base unit positioned about a tube, such that the magnetic base unit cooperates with the magnetically attracted component of the brush to advance the brush through the tube of the medical device.

The tube cleaning mechanism may include an actuating unit, such as a magnetic base device that cooperates or interacts with a metal core incorporated within the brush. The actuating unit may be isolated from the brush mechanism or brush head. Stated otherwise, the actuating unit may be a separate and distinct element or component with respect to the brush mechanisms or brush heads. In other words, the detached actuating unit may actuate movement of a brush mechanism or brush head when the actuating unit approaches or is in the vicinity of or contacts a tube of a medical device configured to receive the brush mechanisms or brush heads. The actuating unit interacts with the brush in a non-attachable manner. The actuating unit activates movement of the brush in a contact-less manner. The actuating unit is configured, in certain embodiments, to slidably engage the exterior surface of the tube or hose. As such, operations and/or functions of the medical device may remain uninterrupted during the cleaning of portions of the medical device via the tube cleaning mechanisms of the exemplary embodiments of the present disclosure.

Additionally, a method of cleaning a medical device may be presented, where a tube cleaning mechanism suitable for use in facilitating cleaning of a passageway defined by a medical device may be presented. The method may include the steps of providing a brush including a magnetically attracted component incorporated therein, positioning a magnetic base unit about the tube of a medical device, and advancing the brush through the tube of the medical device when the magnetic base unit cooperates with the magnetically attracted component of the brush.

A plurality of other applications may be envisioned by a skilled artisan.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

It should be noted that the language used in the specification has been principally selected for readability and instructional purposes, and may not have been selected to delineate or circumscribe the inventive subject matter. Accordingly, the disclosure is intended to be illustrative, but not limiting, of the scope of the present disclosure.

The foregoing examples illustrate various aspects of the present disclosure and practice of the methods of the present disclosure. The examples are not intended to provide an exhaustive description of the many different embodiments of the present disclosure. Thus, although the foregoing present disclosure has been described in some detail by way of illustration and example for purposes of clarity and understanding, those of ordinary skill in the art will realize readily that many changes and modifications may be made thereto without departing form the spirit or scope of the present disclosure.

What is claimed is:

1. A tube cleaning device, comprising:
a brush including a magnetically attracted component incorporated therein; and
a magnetic base unit positioned about a tube;
wherein the magnetic base unit cooperates with the magnetically attracted component of the brush to advance the brush through the tube.

2. The tube cleaning device according to claim 1, wherein the magnetic base unit includes a single magnet.

3. The tube cleaning device according to claim 2, wherein the single magnet circumferentially surrounds at least one section of the tube.

4. The tube cleaning device according to claim 2, wherein the single magnet releasably attaches to the tube across a length of the tube.

5. The tube cleaning device according to claim 2, wherein the single magnet slidably engages the tube throughout a length of the tube.

6. The tube cleaning device according to claim 1, wherein the magnetic base unit includes a pair of opposed magnets.

7. The tube cleaning device according to claim 6, wherein the pair of opposed magnets are incorporated within a housing configured to slidably engage a length of the tube.

8. The tube cleaning device according to claim 7, wherein the housing incorporating the pair of opposed magnets is configured to be adjusted based on a diameter of the tube.

9. The tube cleaning device according to claim 1, wherein the brush includes a brush head including a plurality of bristles and a brush handle, at least a portion of the brush head incorporating the magnetic attracted component therein.

10. The tube cleaning device according to claim 1, wherein a plurality of magnetic base units are positioned across a length of the tube.

11. A method of cleaning a tube, the method comprising:
providing a brush including a magnetically attracted component incorporated therein;
positioning a magnetic base unit about the tube; and
advancing the brush through the tube when the magnetic base unit cooperates with the magnetically attracted component of the brush.

12. The method according to claim 11, wherein the magnetic base unit includes a single magnet.

13. The method according to claim 12, further comprising slidably engaging the single magnet throughout a length of the tube.

14. The method according to claim 11, wherein the magnetic base unit includes a pair of opposed magnets.

15. The method according to claim 14, further comprising incorporating the pair of opposed magnets within a housing configured to slidably engage a length of the tube.

16. The method according to claim 15, further comprising adjusting the housing incorporating the pair of opposed magnets based on a diameter of the tube.

17. The method according to claim 11, wherein the brush includes a brush head including a plurality of bristles and a brush handle, at least a portion of the brush head incorporating the magnetically attracted component therein.

18. A conduit cleaner, comprising:
a magnetically attracted element embedded within a brush mechanism; and
a magnetic element creating a magnetic field about at least one segment of a conduit;
wherein when the magnetic element approaches the magnetically attracted element, the magnetic element propels the brush mechanism through the conduit.

19. The conduit cleaner according to claim 18, wherein the magnetic element is a single magnet that is configured to slidably engage a length of the conduit.

20. The conduit cleaner according to claim 18, wherein the magnetic element is a pair of opposed magnets arranged to be disposed within a housing that is configured to slidably engage a length of the conduit.
